(19) United States
(12) Patent Application Publication
(10) Pub. No.: US 2017/0117532 A1
(43) Pub. Date: Apr. 27, 2017

(54) DETECTING CELL OVER-TEMPERATURE IN A BATTERY CELL

(71) Applicant: Boston-Power, Inc., Westborough, MA (US)

(72) Inventors: Rui E. Frias, East Freetown, MA (US); Nino M. Paldan, Barrington, RI (US)

(21) Appl. No.: 14/919,858

(22) Filed: Oct. 22, 2015

(51) Int. Cl. H01M 2/34; H01M 10/42

(52) U.S. Cl. CPC H01M 2/348; H01M 10/425; H01M 2010/4271; H01M 2220/20

(57) ABSTRACT

A device for indicating over-temperature of one or more battery cells includes a thermal sensor proximate to a battery cell, a controller in electrical communication with the thermal sensor, and a switch and resistor connected in series across the battery cell, which are controlled by the controller. The device detects whether a given battery cell or group of cells reaches a temperature over a threshold temperature. When the threshold is exceeded, the device causes the battery cell to exhibit a duty cycle of voltage change across the terminals of the battery cell. A battery management system (BMS) monitors the voltage of the battery cell and detects the duty cycle as an indication that a temperature fault in the form of a temperature over a threshold temperature has occurred.

### BACKGROUND

Battery cells used in single or battery pack applications are susceptible to increased temperatures, or “over-temperature” beyond temperatures typical of normal, safe operation. In turn, the failure of an individual cell due to over-temperature can propagate to other, neighboring cells, causing wide-scale thermal failure, also known as “thermal runaway.” Generally, a typical battery pack, such as a battery pack implemented in automotive applications (e.g., electric vehicles), includes a thermistor positioned to detect the temperature of the battery pack or a region of the battery pack. This temperature is reported to a battery management system (BMS), which takes action to prevent battery failure in response to detecting an unsafe temperature.

Although a thermistor device within a battery pack can provide a means of temperature fault detection, such devices may fail to indicate a specific cell that is exhibiting a temperature fault. A number of techniques for monitoring multi-cell battery temperature are known. A first technique implements a number of thermistor devices to monitor the temperature of each cell. However, implementing this technique typically is costly because of the number of components required and overall system complexity. A second approach includes monitoring the temperature of a group of cells with a single thermistor device, thereby reducing system cost and complexity. Monitoring the temperature of a group of cells with a single device, however, introduces the risk of masking an unsafe condition if one of the cells becomes significantly hotter than the others.

Alternatively a typical battery module in electric vehicle applications, for example, can include a small number of thermistors, such as thermistor 180, to monitor a greater number of cells (e.g., two thermistors per 12 cells). Such a configuration requires extensive testing to determine the proper placement of the thermistors among the cells. Due to the inability for the BMS to monitor individual cell temperatures in this configuration, the BMS must be configured to have a greater margin of acceptable operating temperatures. Moreover, each thermistor generally must be connected to the BMS and the BMS, in turn, includes circuitry to receive and process each sensor input, adding to the complexity and cost to the battery system.

Therefore, there is a need for a device and method for detecting over-temperature in a battery cell that overcomes or minimizes the above-referenced deficiencies.

### SUMMARY OF THE INVENTION

The invention generally is directed to a device and method for detecting over-temperature in a battery cell.

In one embodiment of the invention, the device includes a thermal sensor, a controller, a switch and an electrical resistor. The thermal resistor is located proximate to at least one battery cell. The controller is in electrical communication with the thermal sensor. The switch is connected across terminals of at least one battery cell and is actuated by the output of the controller. The electrical resistor is connected in series with the switch across the terminals of the battery cell, wherein electrical communication of the switch and the electrical resistor exhibits a duty cycle across the terminals upon actuation by the controller. A temperature of at least one of the battery cells over a minimum threshold causes the thermal sensor to actuate the controller and thereby initiate the duty cycle of the switch and the electrical resistor, causing a change in voltage output by the at least one battery cell, and indicating detection of over-temperature in the battery cell.

In another embodiment, a method of the invention includes monitoring a temperature of a battery cell with a thermal sensor. The measured temperature is compared against a threshold temperature. A switch is actuated at a given duty cycle by a controller in response to a measured temperature over the threshold temperature. The switch is connected in series with an electrical resistor across terminals of a battery cell, whereby a voltage across the battery cell changes in response to the given duty cycle, thereby indicating over-temperature in the battery cell.

The invention provides a number of advantages over existing techniques for temperature monitoring. For example, such embodiments can utilize existing monitoring channels and can employ one or more detectors at the battery module to monitor the temperature of one or more battery cells. If an excessive temperature, or over-temperature, is detected a corresponding fault can be reported to the BMS via existing channels employed to monitor voltage of batteries in a battery pack by a battery management system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a battery system implementing a detector in one embodiment of the invention.

FIG. 2 is a block diagram of a detector device in one embodiment of the invention.

FIG. 3 is a block diagram of a battery system implementing a plurality of detectors in another embodiment of the invention.

FIG. 4 is a flow diagram of operation of a detector device in one embodiment of the invention.

FIG. 5 is a timing diagram illustrating results of a detector device in one embodiment of the invention.

FIG. 6 is a block diagram of a battery system implementing a single detector linked to a plurality of thermistors in yet another embodiment of the invention.

FIG. 7 is a flow diagram of operation of a detector device in a further embodiment of the invention.

### DETAILED DESCRIPTION OF THE INVENTION

The invention generally is directed to detecting over-temperature in a battery cell. “Over-temperature” is defined herein as a temperature above a set threshold. The threshold can be, for example, the maximum temperature considered suitable for normal operation of a battery cell, such as a rechargeable battery cell. A “normal” operating temperature of a battery cell, in turn, can, for example, be considered the maximum temperature at which a battery can be operated safely, or a temperature indicative that the battery cell is experiencing auto catalytic “thermal runaway” and in danger of experiencing catastrophic failure.

Typically, it is desirable to avoid operation of most lithium-ion secondary (i.e., rechargeable) battery cells, for example, above 60° C. Operation at temperatures above 60° C. can significantly shorten the expected cycle life of such battery cells. Further, many secondary battery cells, such as lithium ion battery cells, can enter a thermal runaway condition at elevated temperatures (typically above 75° C.). Thermal runaway can introduce a safety hazard, particularly in multi-cell battery systems, where thermal runaway in one battery can initiate a chain reaction of catastrophic failure among surrounding cells. Therefore, generally, it is important to ensure that all cells in the battery system are operating below 75° C.

Example embodiments of the present invention provide for monitoring the temperature of one or more individual cells within a battery block. If a temperature over a threshold is detected in any cell, or cells, it can be reported as an “over-temperature,” or “temperature fault,” to a battery management system (BMS) via existing channels between the battery pack the BMS. As a result, a battery module can be monitored by an existing BMS without requiring additional circuitry at the BMS.

In one embodiment, a battery system can employ a device of the invention for indicating over-temperature of one or more battery cells. The device detects whether a given battery cell or group of cells reaches a temperature, or over-temperature, which is a temperature over a threshold temperature. When the threshold temperature is exceeded, the device causes a battery cell to exhibit a duty cycle across the terminals of the battery cell. In one embodiment of the invention, a battery management system, or a BMS, that monitors the voltage of the battery cell detects the duty cycle as an indication that a temperature fault in the form of over-temperature has occurred.

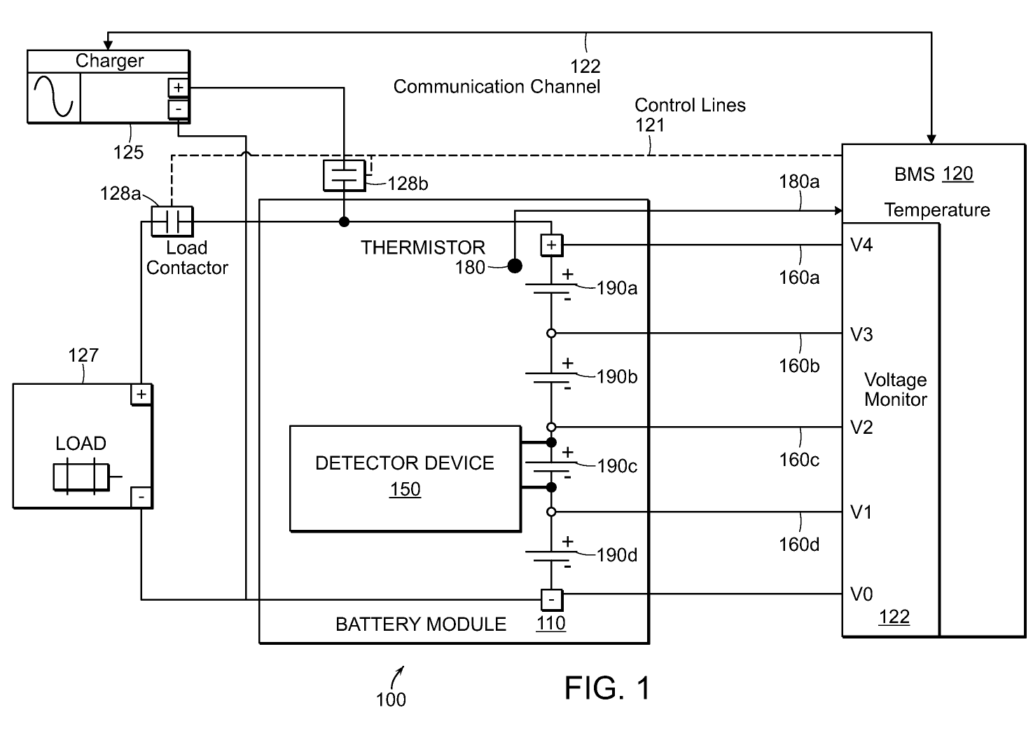

FIG. 1 is a block diagram of battery system 100 that includes one embodiment of the present invention. Battery system 100 includes battery module 110 in connection with battery management system (BMS) 120. Battery module 110 includes plurality of battery cells 190a-d connected in series and to provide power to a load (not shown) via connection across the terminals of one or more of cells 190a-d. Battery module 110 can include a greater or lesser number of cells, connected in series, in parallel, or a combination thereof, as appropriate for an intended application. Battery module 110 can include, for example, one or more battery packs of battery cells arranged in series or in parallel, such as for application in an electric vehicle.

BMS 120 manages battery module 110, as well as any other batteries (not shown) to which it is connected. In managing battery module 110, BMS 120 provides one or more of a number of functions, such as monitoring its voltage, temperature, or state of charge, thereby protecting battery module 110 from operating parameters (e.g., temperature, voltage) determined to be unsuitable for operation, or unsafe, by selectively enabling and disabling the battery cells, calculating and reporting secondary data, and balancing batteries that make up battery module 110. In order to provide such functions, BMS 120 interfaces with battery module 110 through a plurality of channels 160a-d. In particular, BMS 120 includes voltage monitor 122 that receives voltage inputs V0-V4, which connect to terminals across each of cells 190a-d through channels 160a-d. Inputs V0-V4 enable BMS 120, by way of voltage monitor 122, to monitor the voltage of each cell 190a-d individually. BMS 120 also receives a measurement of temperature at battery module 110 via a separate channel 180a connected to thermal resistor (“thermistor”) 180 at battery module 110. Thermistor 180 can be, for example, a PTC device, located proximate to a single cell (e.g., cell 190a), a group of cells, or a separate region of battery module 110. BMS 120 can also interface with battery module 110 via additional channels (not shown) to provide additional monitoring and control of battery module 110.

Under normal operation, battery module 110 selectively delivers power to load 127 (e.g., an electric motor) by connecting cells 190a-d across the terminals of load 127. To control discharge of battery module 110 to power load 127, BMS 120 selectively enables the circuit via load contactor 128a connected to BMS 120 via control lines 121. Battery module 110 is also selectively charged by battery charger 125 by connecting cells 190a-d across the terminals of battery charger 125. To control charging of battery module 110, BMS 120 communicates with charger 125 via communications channel 122 to control charger 125 and receive an indication of the state of the charge, and selectively enables load contactor 128b via control lines 121. Further, during a temperature fault, BMS 120 can halt charging and/or discharging by disabling one or both of load contactors 128a-b.

In one embodiment of the invention, detector device 150 is employed to monitor the temperature of one or multiple individual cells within battery module 110. If a temperature in excess of a predetermined limit, or over-temperature, is detected, a temperature fault is reported to BMS 120 through channels 160a-d employed for monitoring voltage (e.g., V1 and V2) between the battery pack and BMS 120. As a result, detector device 150 can provide per-cell temperature monitoring, or multiple-cell temperature monitoring, to BMS 120 without requiring additional circuitry at the BMS, other than that of detector device 150 itself.

Detector device 150 measures temperature by one or more sensors to detect whether a given battery cell (e.g., cell 190c) or group of cells reaches an over-temperature. Device 150 is also connected across the terminals of each battery cell, such as battery cell 190c, as shown. When a temperature over a threshold temperature is detected, device 150 causes battery cell 190c to exhibit a duty cycle across the terminals of cell 190c. A “duty cycle,” as that term is employed herein, means a pattern of switching that applies an additional load to a battery cell, or battery cells, that causes a corresponding pattern of voltage drop across the battery. The measured pattern of voltage drop across the battery is identifiable as a signal by a voltage monitoring device, such as BMS 120, connected to the respective battery cell or cells.

BMS 120, which monitors the voltage of battery cell 190c, detects the duty cycle as an indication that a temperature fault has occurred. In response, BMS 120 can take appropriate action to ensure the continued safe operation of the battery system 100. For example, BMS 120 can disable charging or discharging of battery module 110, modify operating parameters of battery module 110, or issue an alert for further intervention. For example, if module 110 is charging, BMS 120 can disable further charging; if module 110 is discharging, BMS 120 can send an alert to a vehicle control unit (VCU, not shown), which can, in turn, alert the driver of the vehicle to pull over and stop, thereby terminating discharge of the battery cell, pack, or module, in a safe manner.

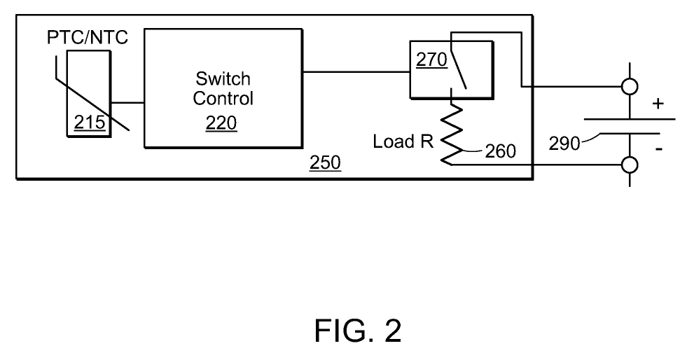

FIG. 2 is a block diagram of detector device 250 in one embodiment of the invention. Detector device 250 can be implemented in battery system 100 described above with reference to FIG. 1, and incorporates features of detector device 150 described above. Detector device 250 includes thermal sensor 215 (e.g., a thermal resistor such as a positive thermal coefficient (PTC) device or a negative thermal coefficient (NTC) device), switch controller 220, switch 270, and resistor 260. Switch 270 and resistor 260 are connected in series across the terminals of battery cell 290. Under normal operation (e.g., safe operating conditions), controller 220 keeps switch 270 in an open state, thereby preventing any current through resistor 260. In alternative embodiments, switch 270 and resistor 260 are connected across the terminals of plural cells, the cells being configured in series or in parallel.

Thermal sensor 215 indicates a local temperature, such as the temperature at a nearby battery cell (e.g., cell 290) or group of cells. Switch controller 220 is in communication with sensor 215 to monitor this temperature and compare it against a threshold temperature. The threshold temperature can be selected, for example, to correspond to a safe operating temperature of cell 290. If controller 220 detects that this threshold is exceeded, controller 220 outputs a switch control signal to switch 270. The switch control signal can oscillate at a given frequency, thereby alternating switch 270 on and off at the given frequency. This switching, in turn, opens and closes the circuit of switch 270, resistor 260, and cell 290. As a result, the voltage across cell 290 exhibits a “duty cycle” corresponding to the given frequency, and this duty cycle is detected by a BMS (e.g., BMS 120 in FIG. 1) to indicate a temperature fault. Summarizing, detector 250 detects a temperature via sensor 215, determines via controller 220 whether this temperature is an over-temperature (exceeding a threshold) and, if so, communicates this information by alternately switching on a load (via switch 270 and resistor 260) across the terminals of battery cell 290, causing the voltage across cell 290 to exhibit a duty cycle that is detected by a BMS.

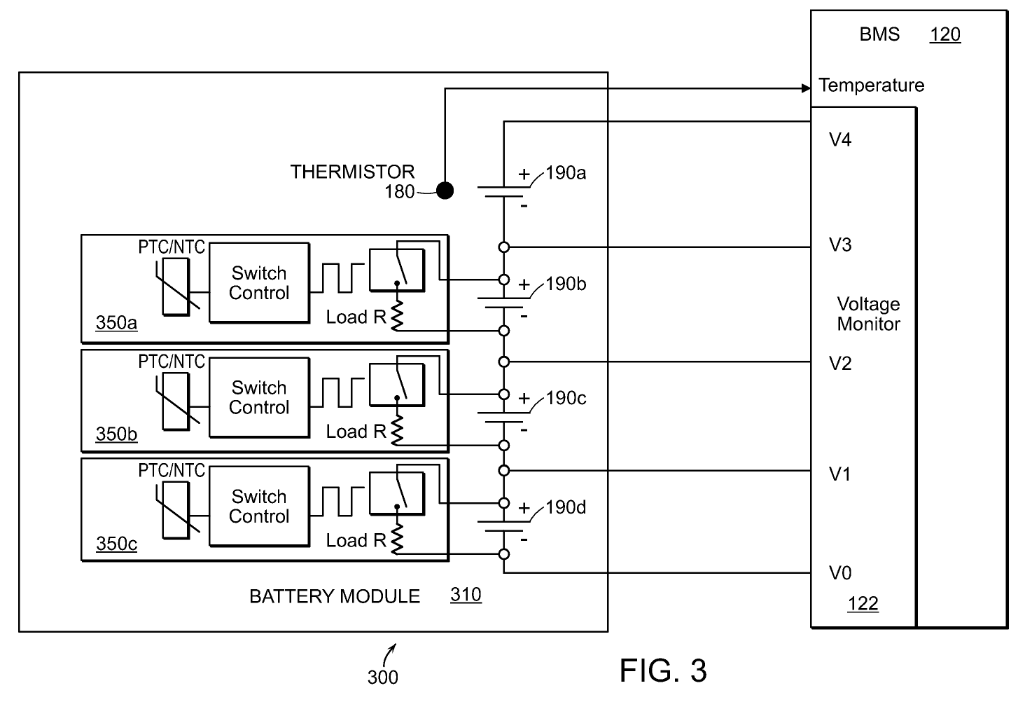

FIG. 3 is a block diagram of battery system 300 implementing plurality of detectors 350a-c in one embodiment of the invention. Battery system 300 includes battery module 310, which incorporates features of battery module 110 described above with reference to FIG. 1. Similarly, BMS 120, with voltage monitor 122, interfaces with battery module 310, and monitors voltage and temperature of battery cells 190a-d as described above with reference to FIG. 1. In contrast to system 100 of FIG. 1, battery module 310 includes three detector devices 350a-c, each of which incorporate features of devices 150, 250 described above. Each device 350a-c is connected to corresponding battery cell 190b-c, respectively, and includes one or more thermal sensors (e.g., sensor 215 in FIG. 2) positioned to measure temperature at each of corresponding battery cells 190b-d. When devices 350a-c detect a temperature above a threshold temperature at any corresponding battery cell 190b-d, they indicate a temperature fault by causing the voltage across corresponding cell 190b-d to exhibit a duty cycle. This voltage, modified by the duty cycle, is then be detected by voltage monitor 122 of BMS 120 (via inputs V1-V4), enabling BMS 120 to take appropriate action to address the temperature fault.

Battery module 310 also includes thermistor 180, which measures a temperature at battery cell 190a and report the temperature to BMS 120 via a corresponding channel. In alternative embodiments, battery module 310 implements a combination of one or both thermistors (e.g., thermistor 180) and detector devices (e.g., devices 350a-c) to monitor temperature at one or more of cells 190a-d. For example, battery module 310 can include a detector device such as devices 350a-c for each of cells 190a-d. In such a configuration, thermistor 180 is omitted, and BMS 120 acquires temperature indications entirely via voltage monitor 122. Alternatively, the thermistor 180 can be included, but positioned to measure temperature at a portion of the battery module 310 other than at a battery cell, such as the ambient temperature of the entire battery module 310 or battery system 300.

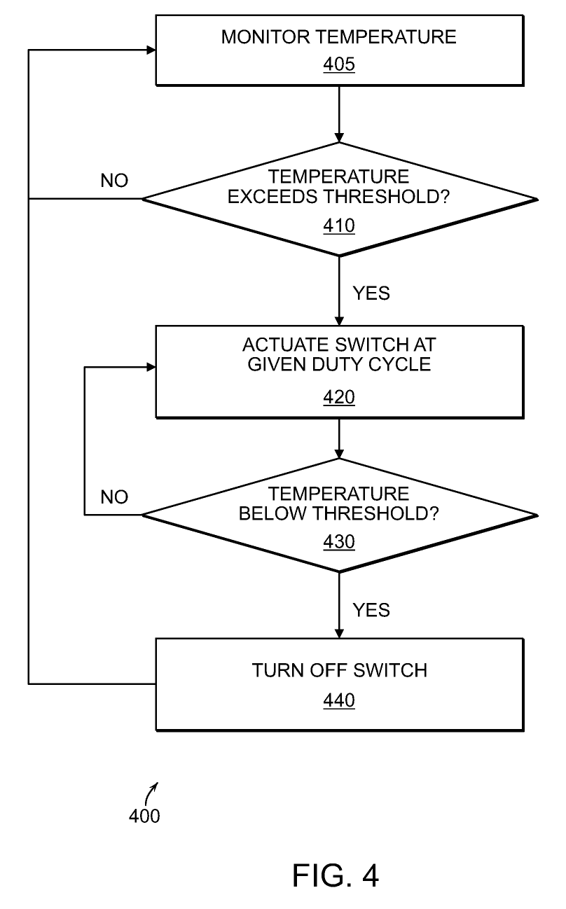

FIG. 4 is a flow diagram of process 400 operated by a detector device in one embodiment of the invention. Process 400 is implemented, for example, by one or more of detector devices 150, 250, 350a-c described above with reference to FIGS. 1-3.

With reference to FIG. 2, upon initialization, controller 220 keeps switch 270 in an open state, thereby preventing any current through resistor 260. Detector 250 monitors a temperature (e.g., at an associated cell or cells) via sensor 215 and switch controller 220 (405). Switch controller 220 continuously or periodically compares the measured temperature against a threshold temperature (410). If controller 220 detects that this threshold is exceeded (by being an over-temperature), controller 220 outputs a switch control signal to switch 270, thereby actuating the switch at a given duty cycle (420). This switching, in turn, causes the voltage across cell 290 to exhibit a corresponding duty cycle, and this duty cycle is detected by a BMS (e.g., BMS 120 in FIG. 1) to indicate a temperature fault.

Device 250 continues to cause this duty cycle until switch controller 220, via sensor 215, detects that the temperature is below a second threshold temperature (equal to, or distinct from, the threshold described above) (430). Upon crossing this second threshold, controller 220 then turns off switch 270 (440), and returns to monitoring the temperature as described above (405). Alternatively, controller 220 turns off switch 270 after a predetermined period of time (e.g., a time sufficient to communicate the temperature fault to a BMS).

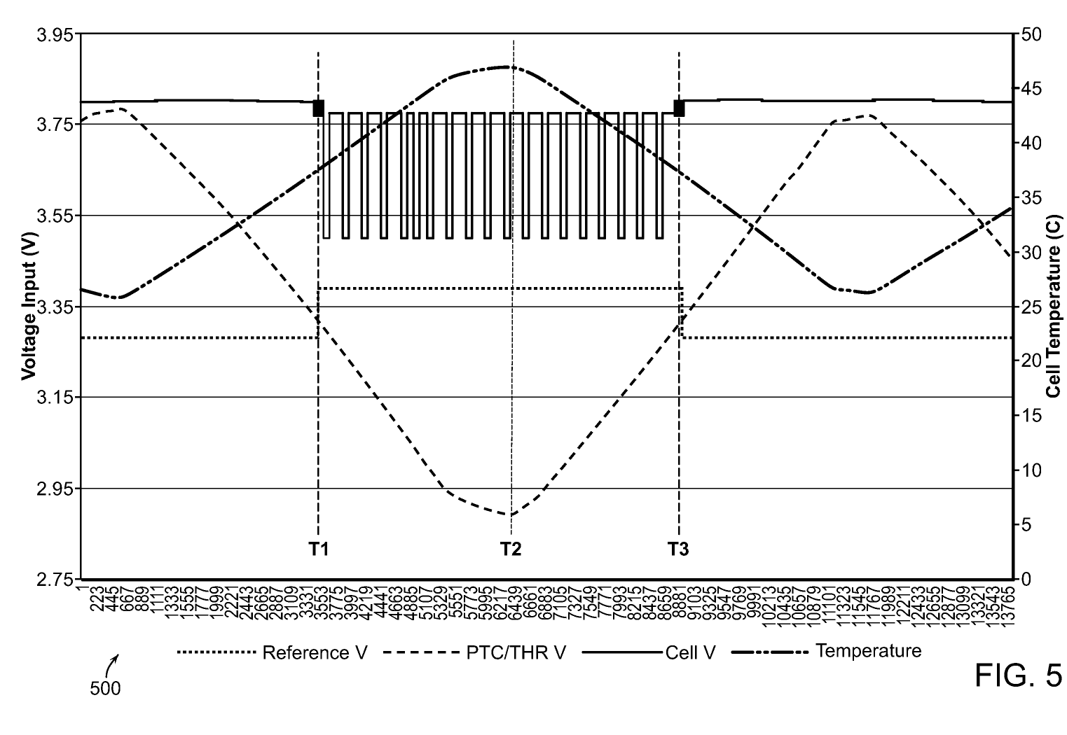

FIG. 5 is a timing diagram illustrating results of a detector device in one embodiment of the invention. With reference to FIG. 2, at the start time, the temperature of cell 290, as measured by sensor 215, is approximately 26° C., which is below the selected maximum temperature threshold of 38° C. Accordingly, switch 270 is off, and voltage across the cell 290 maintains a normal, steady-state value. However, over time, the cell temperature increases until, at time T1, it exceeds the temperature threshold as an over-temperature. This increase is indicated by the voltage across sensor 215 (a thermal resistor) which decreases in tandem. In response, detector device 250 causes the voltage across cell 290 to exhibit a duty cycle, which, in turn, is detected by a BMS interfacing with cell 290, registering a temperature fault at cell 290. The maximum temperature threshold can be selected to be equal to or less than a temperature determined to be a maximum safe operating temperature of cell 290.

The BMS interfacing with cell 290 takes action responsive to the temperature fault, such as by halting charging or discharging of the cell 290 or plural cells. At time T2, current flow at cell 290 has ceased, resulting in a temperature peak and a subsequent decrease. The temperature then continues to decrease until it drops below the temperature threshold at time T3, indicating return to a safe operating temperature. Accordingly, detector device 250 then turns off switch 270, enabling the voltage across cell 290 to return to a steady-state value (i.e., absent the duty cycle).

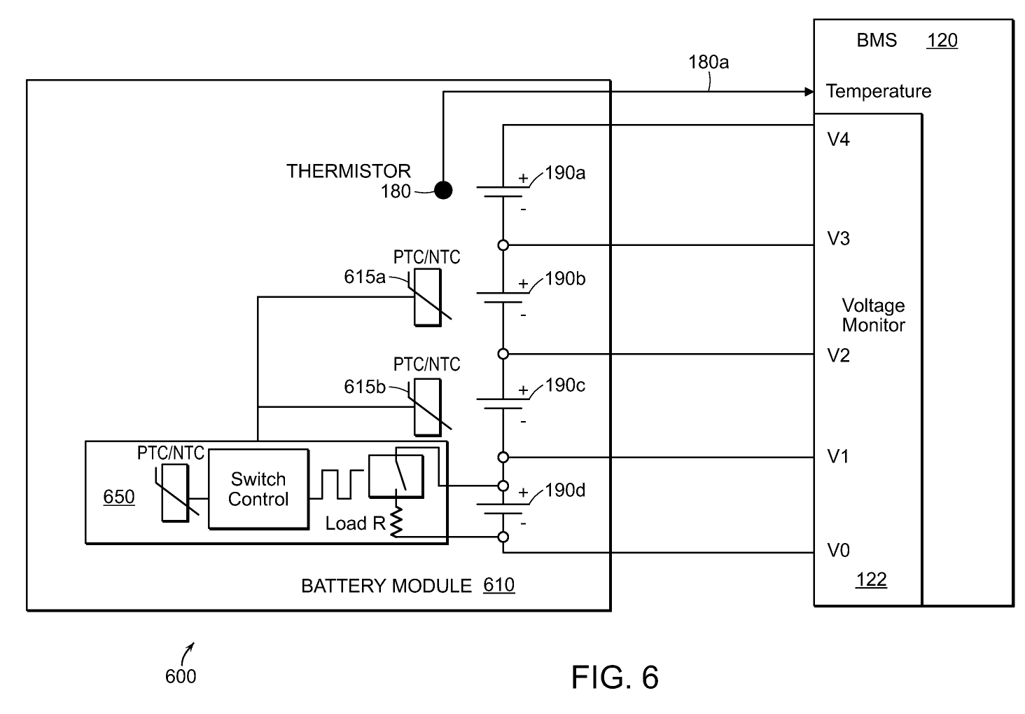

FIG. 6 is a block diagram of battery system 600 in a further embodiment of the invention. Battery system 600 includes battery module 610, which may incorporate features of battery modules 110, 310 described above with reference to FIGS. 1 and 3. Similarly, BMS 120, with voltage monitor 122, interfaces with battery module 610, and monitors voltage and temperature as described above with reference to FIGS. 1 and 3. In contrast to systems 100, 300 of FIGS. 1 and 3, respectively, battery module 610 includes single detector device 650, which incorporates features of devices 150, 250, 350 described above. Device 650 is connected to corresponding battery cell 190d, and includes one or more thermal sensors (e.g., sensor 215 in FIG. 2) positioned so as to measure temperature at the corresponding battery cell 190d. When device 650 detects a temperature over a threshold temperature at corresponding battery cell 190d, it indicates a temperature fault by causing the voltage across corresponding cell 190d to exhibit a duty cycle. This voltage, modified by the duty cycle, is then be detected by voltage monitor 122 of BMS 120 (via inputs V0 and V1), enabling BMS 120 to take appropriate action to address the temperature fault.

In addition, detector device 650 is connected to individual thermal sensors 615a-b. Thermal sensors 615a-b include, for example, a PTC device, are located proximate to single corresponding cell 190b-c, respectively, and monitor temperature at corresponding cell 190b-c. Alternatively, sensors 615a-b are located proximate to a group of cells, or a separate region of battery module 610.

In addition (or as an alternative) to detecting temperature at a sensor internal to detector device 650, device 650 may detect the temperature at each of individual thermal sensors 615a-b and determine whether the temperatures exceed a temperature threshold. In response to detecting an excessive temperature at thermal sensors 615a-b and/or a sensor internal to device 650, device 650 indicates a temperature fault by causing the voltage across corresponding cell 190d to exhibit a duty cycle and thereby communicate the fault to BMS 120. As a result, detector device 650 reports temperature faults individually for the plurality of battery cells 190b-d.

In further embodiments of the invention, detector device 650 communicates information about the temperature fault, such as an indication of the cell or cells exhibiting an excessive temperature, by selecting the duty cycle from among a plurality of possible duty cycles. For example, if detector device 650 detects a temperature fault at cell 190b (via sensor 615a), detector device 650 can cause the voltage across cell 190d to have a first duty cycle. Further, if detector device 650 detects a temperature fault at cell 190c (via sensor 615b), detector device 650 can cause the voltage across cell 190d to have a second duty cycle, distinct from the first duty cycle. BMS 120 is configured to identify the duty cycle across cell 190d as one of the first or second duty cycles, as well as interpret the identified duty cycle as being associated with a particular thermal sensor, battery cell, or location of battery module 610. In response, BMS 120 can take appropriate action directed to the temperature fault, such as by issuing a command to battery module 610 to stop current flow, including charging and discharging of the one or more of battery cells 190a-d.

Battery module 610 includes thermistor 180, which is configured to measure a temperature at battery cell 190a and report the temperature to BMS 120 via a corresponding channel (i.e., V4). In alternative embodiments of the invention, battery module 610 implements a combination of one or more of thermistors (e.g., thermistor 180) detector devices (e.g., device 650) and individual temperature sensors linked to a detector device (e.g., sensors 615a-b) to monitor temperature at one or more of cells 190a-d. For example, battery module 610 can include individual sensors such as the sensors 615a-b, linked to common detector device 650, for each of cells 190a-d. In such a configuration, thermistor 180 can be omitted, and BMS 120 can acquire temperature indications entirely via the voltage monitor 122. Alternatively, thermistor 180 may be included, but positioned to measure temperature at a portion of battery module 610 other than at a battery cell, such as the ambient temperature of entire battery module 610 or battery system 600.

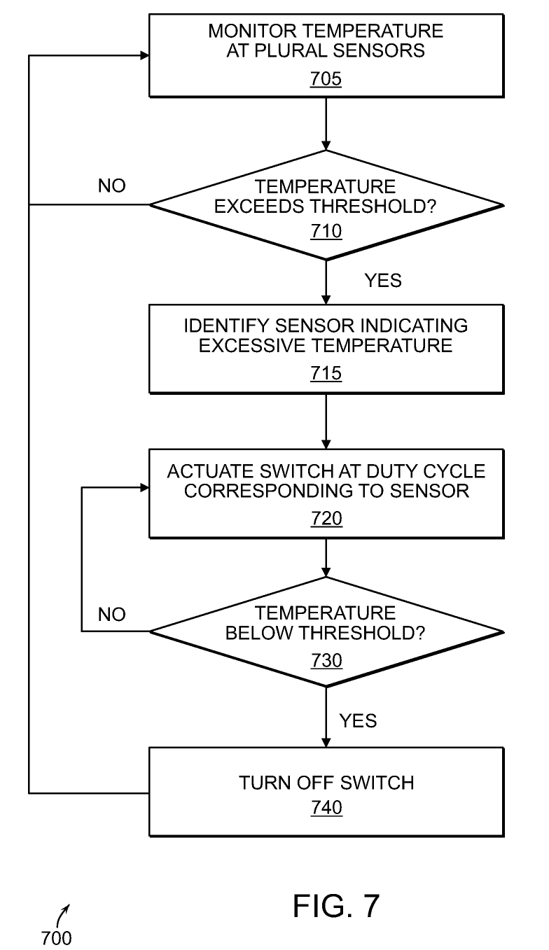

FIG. 7 is a flow diagram of process 700 operated by a detector device in one embodiment of the invention. Process 700 can be implemented, for example, by one or more of detector devices 150, 250, 350a-c, 650 described above with reference to FIGS. 1-3 and 6. In particular, process 700 can facilitate communication of a temperature fault to a BMS, as well as an indication of the location of the temperature fault. This feature may have particular utility in detector device 650, which is configured to monitor temperature at a plurality of sensors.

With reference to FIG. 2, upon initialization, controller 220 may keep switch 270 in an open state, thereby preventing any current through resistor 260. Detector 250 monitors a temperature (e.g., at an associated cell or cells) via sensor 215 and switch controller 220 (705). Switch controller 220 continuously or periodically compares the measured temperature against a threshold temperature (710). If controller 220 detects that this threshold is exceeded, controller 220 can first identify the particular sensor (e.g., of a plurality of connected sensors) providing the excessive temperature measurement (715). Controller 220 can then determine (e.g., by referencing a lookup table) the particular duty cycle corresponding to the identified sensor, and output a corresponding switch control signal to switch 270, thereby actuating the switch at the duty cycle corresponding to the sensor (720). This switching, in turn, causes the voltage across cell 290 to exhibits a corresponding duty cycle, and this duty cycle can be detected by a BMS (e.g., BMS 120 in FIG. 1) to indicate a temperature fault at the particular sensor.

Device 250 continues this duty cycle until switch controller 220, via sensor 215, detects that the temperature is below a second threshold temperature (distinct from the threshold temperature described above) (730). Upon crossing this second threshold, controller 220 turns off the switch (740), and return to monitoring the temperature as described above (705). Alternatively, controller 220 turns off the switch after a predetermined period of time (e.g., a time sufficient to communicate the temperature fault to a BMS).

While this invention has been particularly shown and described with reference to example embodiments thereof, it will be understood by those skilled in the art that various changes in form and detail may be made therein without departing from the scope of the invention encompassed by the appended claims.

What is claimed is:

1. A device for detecting over-temperature in a battery cell, comprising:
a) a thermal sensor proximate to at least one battery cell;
b) a controller in electrical communication with the thermal sensor;
c) a switch across terminals of the at least one battery cell, the switch being actuated by the output of the controller; and
d) an electrical resistor connected in series with the switch across the terminals of the at least one battery, wherein electrical communication of the switch and electrical resistor exhibits a duty cycle across the terminals upon actuation by the controller, and whereby a temperature of at least one of the battery cells over a threshold causes the thermal sensor to actuate the controller and thereby initiate the duty cycle of the switch and the electrical resistor, causing a change in voltage output by the at least one battery cell, thereby detecting over-temperature in the battery cell.

2. The device of claim 1, further including a battery management system in electrical communication with the at least one battery cell, whereby initiation of the duty cycle is detected by the battery management system as a change in voltage output by the at least one battery cell, thereby providing the indication of excessive temperature in the battery cell to the battery management system.

3. The device of claim 2, wherein the switch and resistor span a single battery cell.

4. The device of claim 2, including a plurality of switches and resistors, each switch and resistor pair spanning a battery cell of a plurality of battery cells connected in series.

5. The device of claim 4, wherein the device includes a plurality of controllers, each of the plurality of controllers in electrical communication with at least one switch and resistor pair.

6. The device of claim 5, further including at least one thermal sensor in electrical communication with a plurality of the controllers.

7. The device of claim 5, wherein each thermal sensor is linked to a separate controller, each controller is linked to a separate pair of a switch and an electrical resistor connected in series, and each pair of the switch and the electrical resistor connected in series is connected to the terminals of a single battery cell.

8. The device of claim 3, further including a plurality of thermal sensors, each thermal sensor proximate to each of a respective member of a plurality of the battery cells, and wherein the controller is electrically-connected to the plurality of thermal sensors, whereby a temperature over a threshold at any of the thermal sensors will actuate the controller and thereby actuate the duty cycle of the switch and electrical resistor across the terminals of the at least one battery cell.

9. The device of claim 8, wherein the duty cycle initiated by the controller has a frequency that is dependent upon the thermal sensor that actuates the controller, thereby identifying to the battery management system the battery cell causing actuation of the controller.

10. The device of claim 2, further including a modular thermistor proximate to the terminals of at least one battery, and in electrical communication with the battery management system, whereby activation of the modular thermistor by exposure of the modular thermistor to a temperature over a minimal threshold is detected by the battery management system.

11. A method for detecting over-temperature in a battery cell, comprising the steps of:
a) monitoring a temperature of a battery cell with a thermal sensor;
b) comparing the temperature against a threshold temperature; and
c) actuating a switch at a given duty cycle in response to output by a controller at a measured temperature over the threshold temperature, the switch being connected in series with an electrical resistor across terminals of a battery cell such that a voltage across the battery cell changes in response to the duty cycle, thereby detecting over-temperature in the battery cell.

12. The method of claim 11, further comprising the steps of detecting, at a battery management system, the duty cycle exhibited by the voltage charge across the battery cell to thereby provide indication of excessive temperature in the battery cell.

13. The method of claim 12, wherein the battery system includes a plurality of batteries connected in series.

14. The method of claim 13, further comprising the steps of:
a) separately monitoring the temperature of each of a plurality of battery cells; and
b) comparing the temperature of each battery cell against a threshold temperature for each of the plurality of battery cells, whereby the identity of any cell exhibit a temperature in excess of the threshold can be determined by the battery management system.
